(19) United States
(12) Patent Application Publication
(10) Pub. No.: US 2022/0295605 A1
(43) Pub. Date: Sep. 15, 2022

(54) INDUCTIVE COOKTOP WITH INTEGRATED DISPLAY

(71) Applicant: GHSP, Inc., Grand Haven, MI (US)

(72) Inventors: CORT C. CORWIN, (US); JOSIAH BONEWELL, Grand Rapids, MI (US); Richard Harris, Kentwood, MI (US); Andrew Foley, Holland, MI (US)

(21) Appl. No.: 17/637,017

(22) PCT Filed: Aug. 21, 2020
(86) PCT No.: PCT/US2020/047427

§ 371 Date: Feb. 21, 2022

Related U.S. Application Data
(60) Provisional application No. 62/889,865, filed on Aug. 21, 2019.

(51) Int. Cl. H05B 6/12; H05B 3/74

(52) U.S. Cl. CPC H05B 6/1218; H05B 3/74

(57) ABSTRACT

An inductive cooktop includes a top plate that has an upper surface that supports a cookware object. An induction coil is disposed below the top plate and is operable to generate an electromagnetic field that is configured to heat the cookware object. A display, such as an OLED display, is disposed between the inductive coil and the top plate and operates to emit light through the top plate, such as to display information that is visible at the upper surface of top plate. A transparent thermal insulator is provided to prevent the cookware object from heating the display above a threshold temperature. The transparent thermal insulator may include a silica aerogel material, which may be disposed between an upper glass panel and a lower glass panel.

### CROSS-REFERENCE TO RELATED APPLICATION

This application claims priority under 35 U.S.C § 119(e) to U.S. Provisional Patent Application No. 62/889,865, filed Aug. 21, 2019, the disclosure of this prior application is considered part of this application and is hereby incorporated by reference in its entirety.

### TECHNICAL FIELD

The present disclosure generally relates to an inductive cooktop with display features and to systems and methods for user interaction with an inductive cooktop.

### BACKGROUND

Kitchens or other areas used to prepare and cook food may have an inductive cooktop, such as a cooktop that is part of a range unit or a separate cooktop unit that is placed on or installed directly in a countertop or other work surface. It is known that inductive cooktops can be used to effectively heat metal cookware that is capable of inductively coupling with an electromagnetic field generated by the cooktop. It is also generally appreciated that the cookware that is heated by an inductive cooktop can conductively distribute heat to surfaces that contact the cookware, such as the top surface of an inductive cooktop.

### SUMMARY

The present disclosure provides an inductive cooktop that includes a top plate and an induction coil that is disposed below the top plate, where the induction coil operates to generate an electromagnetic field that can inductively couple with and heat a cookware object supported on the top plate. The cookware object may generally include a ferrous metal and may be implemented as various types of cooking vessels, such as a pot, a pan, an induction plate, a wok, and the like or in some examples a packaged food item. A display is disposed between the inductive coil and the top plate and operates to emit light through the top plate, such as to display graphics and information at the upper surface of the top plate. The display may be a back-lit liquid-crystal display (LCD) or an organic light emitting diode (OLED) display. The display may also be generally void of ferrous metals or other materials that can be heated to undesirable levels by the electromagnetic field. A transparent thermal insulator is disposed between the top plate and the display to prevent the cookware object from heating the display above a threshold temperature, such as a temperature that is capable of damaging or deteriorating the effectiveness of the display. The transparent thermal insulator provides a greater insulating capacity than static air, such the thickness of the transparent thermal insulator is configured to create a distance between the induction coil and the top plate that is less than the induction coil's operational threshold. Before, during, or after operation of the induction coil, the display may display information through the transparent thermal insulator that is visible at the upper surface of top plate, such as information related to hot areas of the upper surface, operational information of the cooktop, or other media or advertising or the like.

In some examples, the transparent thermal insulator may be disposed between an upper glass panel and a lower glass panel, such as the top plate being the upper glass panel and the lower glass panel being in planar parallel alignment with the upper glass panel. The glass panels may include a glass-ceramic, silica glass, porcelain, polymer thermoplastic, among other types of glass and the transparent thermal insulator may be a silica aerogel material or the like. The transparent thermal insulator is sold and may have a generally consistent thickness between the upper and lower glass panels, such as less than approximately 5 mm. Furthermore, in some examples the transparent thermal insulator may be sandwiched in the top plate, such that the upper and lower glass panels may be considered parts of the top plate. In such examples, the top plate may have a visible transmittance between its upper and lower surfaces that is generally greater than 70%. In other examples, the lower glass panel may be integrated with the display, such that the transparent thermal insulator is overlaid on the display.

The upper surface of the top plate may have a cooking area that is defined by an overlapping portion of the magnetic field at the upper surface. The cooktop may include a controller that is coupled to the induction coil and the display for the controller to control the display, such as to display information at the upper surface of the cooking area. In some examples, when a cookware object is placed on the cooking area and inductively coupled with the induction coil, the display may be controlled to display information at an interfacing portion of the cooking area that interfaces with the cookware object, such as to display a warning indicator at a portion of the upper surface of top plate that is hot.

According to one aspect of the present disclosure, an inductive cooktop may include a top plate that has an upper surface that is configured to support a cookware object. An induction coil may be disposed below the top plate and may be operable to generate an electromagnetic field that is configured to heat the cookware object. A display, such as an LCD or OLED display, may be disposed between the inductive coil and the top plate and may operate to emit light through the top plate, such as to display information that is visible at the upper surface of top plate. A transparent thermal insulator is disposed between the top plate and the display that is configured to prevent the cookware object from heating the display above a threshold temperature, such as a temperature less than or approximately 40 degrees Celsius. The transparent thermal insulator may include a silica aerogel material, which may be disposed in an intermediate layer between an upper glass panel and a lower glass panel.

According to another aspect of the present disclosure, an inductive cooktop includes a top plate that has an upper surface that is configured to support a cookware object. An induction coil is disposed below the top plate and is operable to generate an electromagnetic field toward the upper surface of the top plate that defines a cooking area. A display, such as an LCD or OLED display, is disposed between the inductive coil and the top plate and operates to display information through the top plate. A controller is configured to control the display to display information at an interfacing portion of the cooking area of the upper surface that interfaces with a cookware object inductively coupled with the induction coil. In some implementations, the controller is configured to control the display to display a warning indicator at a portion of the upper surface of top plate that is has a temperature above a threshold warning temperature. Also, the controller may be configured to determine where a heated portion is located on the cooking area based on sensed resistance in the magnetic field from a cookware object inductively coupled with induction coil.

According to yet another aspect of the present disclosure, an inductive cooktop includes a top plate that has an upper surface that is configured to support a cookware object. An induction coil may be disposed below the top plate and may be operable to generate an electromagnetic field at the upper surface of the top plate that defines a cooking area. A display, such as an LCD or OLED display, is disposed below the top plate. A transparent thermal insulator is disposed between the top plate and the display, such that the display is operable to display information at the upper surface of the top plate. A user interface device is provided that magnetically attaches at the upper surface of the top plate and is configured to receive inputs from a user for controlling the induction coil and/or the display. The interface device may be removable and selectively attached to various locations on the upper surface of the top plate, such as adjacent to a portion of the cooking area that interfaces with a cookware object. The interface device may include a rotatable knob that is rotatable relative to a base portion of the knob attached to the top plate. The rotatable knob may provide user inputs that correspond with a radial position of the rotatable knob, such as to adjust temperature or cooking time or the like.

These and other objects, advantages, purposes, and features of the present disclosure will become apparent upon review of the following specification in conjunction with the drawings.

### BRIEF DESCRIPTION OF THE DRAWINGS

FIG. 1 is a perspective view of an inductive cooktop;

FIG. 1A is a perspective view of the inductive cooktop, showing warning information displayed at a prior heating location of a pan shown on the cooktop in FIG. 1;

FIG. 1B is a perspective view of the inductive cooktop, showing a pot moved from the location shown in FIG. 1A and displaying warning information at the prior heating location;

FIG. 1C is a top plan view of the inductive cooktop shown in FIG. 1;

FIG. 2 is a cross-sectional view of an inductive cooktop;

FIG. 2A is a partial cross-sectional view of an inductive cooktop, showing a portion of a transparent thermal insulator between a top plate and a display;

FIG. 3 is a cross-sectional view of another example of an inductive cooktop having a transparent thermal insulator between a top plate and a display;

FIG. 4 is a cross-sectional view of an additional example of an inductive cooktop with a static air gap between a top plate and a display;

FIG. 5 is a perspective view of an inductive cooktop having a top plate exploded upward to show a transparent thermal insulator in a tiled arrangement;

FIG. 5A is an enlarged view of the transparent thermal insulator shown in FIG. 5;

FIG. 6A is a graph of light transmission comparing transparent aerogel with glass;

FIG. 6B is a bar graph of R-values comparing transparent aerogel with glass;

FIG. 7 is a cross-sectional view of another example of an inductive cooktop, showing a localized transparent thermal insulator below a static heating location;

FIG. 7A a top plan view of an inductive cooktop with static heating locations;

FIG. 8 is an upper perspective view of an interface device;

FIG. 9 is a perspective view of an inductive cooktop, showing the interface device of FIG. 8 removably attached to the upper surface of the top plate; and

FIG. 10 is another perspective view of the inductive cooktop shown in FIG. 9, showing the interface device moved to a different location on the upper surface of the top plate;

### DETAILED DESCRIPTION

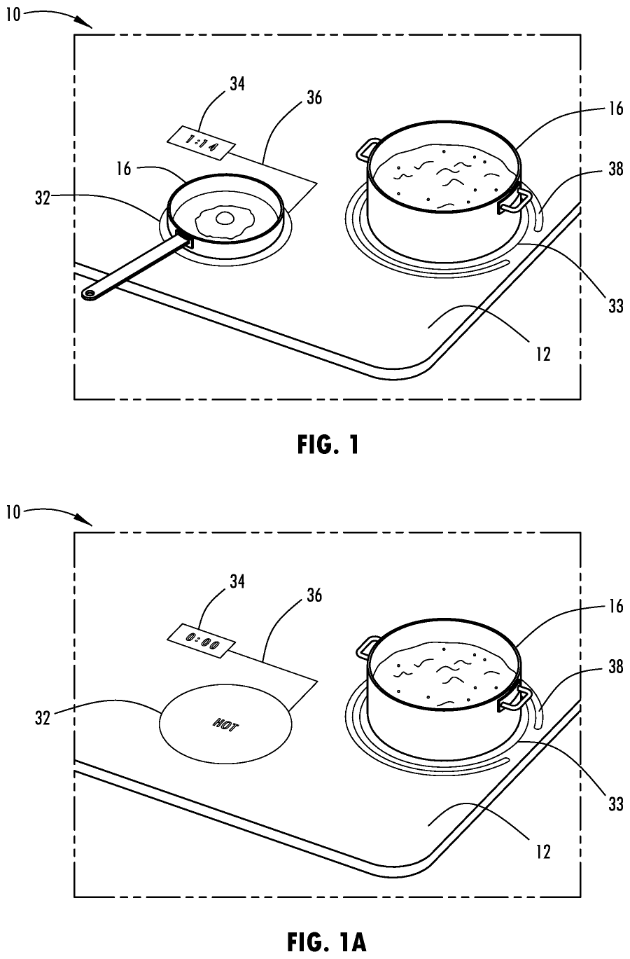

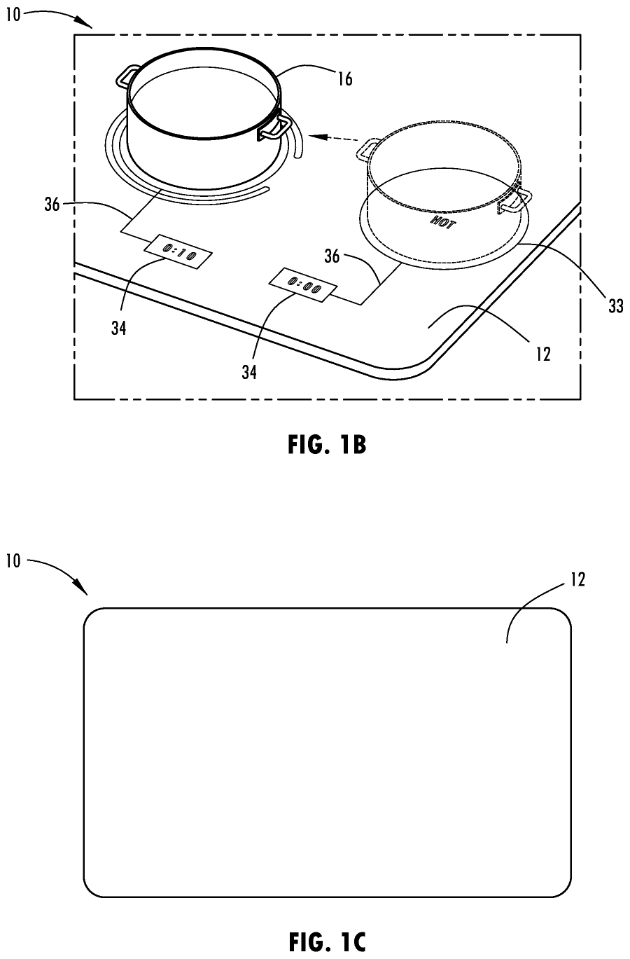

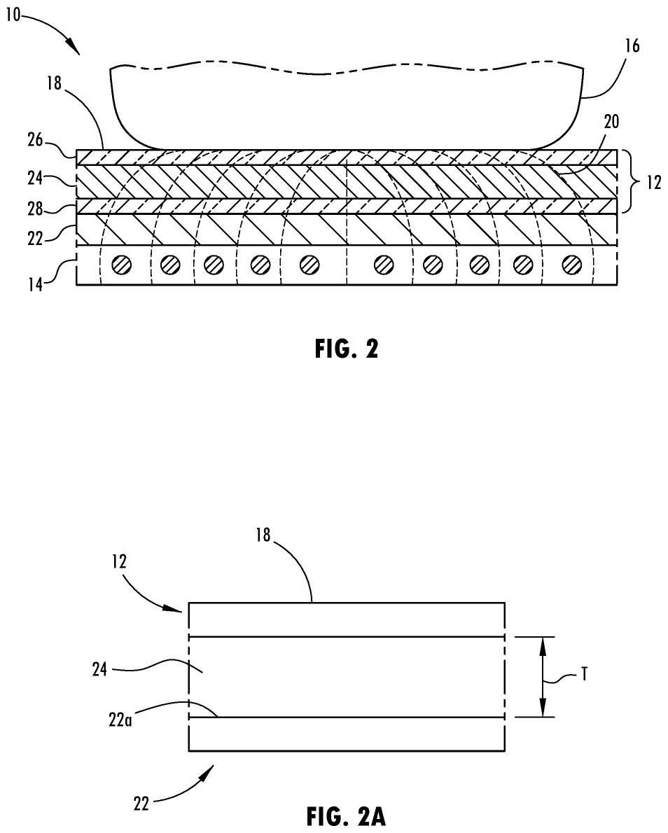

Referring now to the drawings and the illustrative embodiments depicted therein, an inductive cooktop 10 may be provided in a kitchen or other area used to prepare and cook food, such as the inductive cooktop 10 shown in FIGS. 1-1C that is installed in a countertop. The inductive cooktop 10 has a top plate 12 and an induction coil 14 (FIG. 2) that is disposed below the top plate 12. A power supply is provided to supply alternating current, such as high-frequency or medium-frequency current, to the induction coil 14 to create an electromagnetic field. The inductive cooktop 10 may include one or several induction coils 14, such an in a grid or array to provide a flexible or adaptable cooking area by activating a select grouping of the coils. The inductive coil or coils may be provided with conductive material in one or more different shapes, such as a pancake shape or the like.

As shown in FIG. 2, the electromagnetic field 20 is generated in a configuration toward the top plate 12 to inductively couple with and heat a cookware object 16 supported on an upper surface 18 of the top plate 12. The electromagnetic field 20 extends toward and permeates through the upper surface 18 of the top plate 12 in the area immediate above the activated induction coil 14. The electromagnetic field 20 oscillates to create eddy currents in or near the bottom portion of the cookware object 16 that is supported on the top plate 12, such that the resistance of the cookware object to the eddy currents causes resistive heating of the cookware object 16. The inductively heated cookware object 16 may then be used to heat and/or cook the contents of the cookware. To adjust cooking settings, such as the temperature of the cookware object 16, the current supplied to the induction coil 14 may be adjusted by the user, such as via a user interface on the cooktop 10.

The cookware object 16 may include a ferrous metal that is capable of inductively coupling with the induction coil 14 and conductively transferring the heat to the cooking surface of the cookware object. For example, the ferrous metal may be provide at a base of the cookware object near or in contact with the upper surface 18 of the top plate 12. Also, the cookware object 16 may include various types of cooking vessels, such as a pot, a pan, an induction plate, a wok, and the like. It is also contemplated that the cookware object may be product packaging, such as a metal food packaging that is configured to be used without an underlying piece of cookware.

As shown in FIGS. 1-4, a display 22 is disposed between the induction coil 14 and the top plate 12 and operates to emit light through the top plate 12, such as to display graphics and information at the upper surface 18 of the top plate 12. The display 22 may be an organic light emitting diode (OLED) display and may be generally void of ferrous metals or other materials that can be heated by the electromagnetic field generated by the induction coil 14, such at least not substantially heated as above an undesirable threshold. The OLED display may substantially not interfere with the magnetic field created during induction due to its generally non-ferrous material construction. It is also contemplated that other types of displays, such as a back-lit liquid-crystal display (LCD), may be utilized in additional implementations of the inductive cooktop.

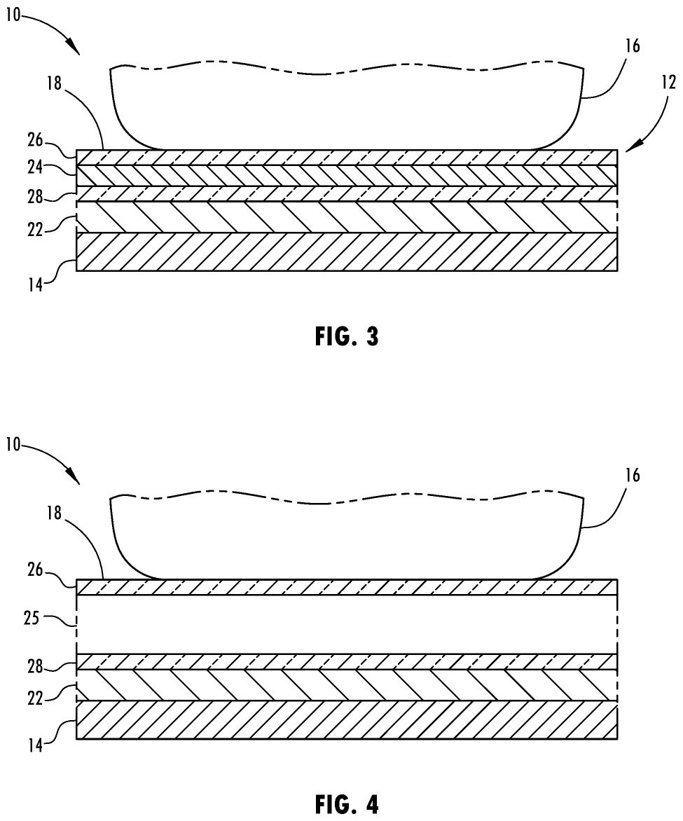

A transparent thermal insulator 24 is provided between the upper surface 18 of the top plate 12 and the display 22 to prevent the heated cookware object 16 from conductively heating the underlying display 22 above a threshold temperature, such as a temperature that is capable of damaging or deteriorating the effectiveness of the display 22. As shown in FIGS. 2-3, the transparent thermal insulator 24 is a silica aerogel material that is disposed between an upper surface of the display 22 and a substrate that forms the upper surface 18 of the top plate 12. The transparent thermal insulator may be integrated with the top plate (as shown in FIG. 2), may be separately disposed between the top plate 12 and the display 22 (as shown in FIG. 3), may be integrated with the upper substrate of the display, or may be provided in any combination of these arrangements.

As shown in FIG. 2, the top plate 12 has an upper glass panel 26 and a lower glass panel 28 that is in substantially planar parallel alignment with the upper glass panel 26. The transparent thermal insulator 24 is sandwiched between the upper and lower glass panels 26,28 in a layer with a generally uniform thickness. The transparent thermal insulator 24 has a generally consistent thickness between the upper and lower glass panels, such as less than or equal to approximately 5 mm or less than or equal to approximately 7 mm. As shown in FIG. 2, the transparent thermal insulator 24 includes a homogenous panel of silica aerogel that is disposed in direct contact with the glass panels to provide an appearance of a single glass panel with a uniform thickness. Thus, the top plate 12 shown in FIG. 2 has a sandwich construction with a highly thermal isolating layer, provided by the transparent thermal insulator 24 disposed between the upper and lower glass panels 26, 28. The term “glass” as used in describing the glass panels 26, 28 refers generally to its translucent and solid properties of the material, as the glass panels 26, 28 may include one or more of glass-ceramic, silica glass, porcelain, polymer thermoplastic, among other types of glass. It is also contemplated that some implementations of the top plate or a portion thereof may have a non-planar upper surface, such as to form a concave or convex curvature in an area that may be configured to mate with a cookware object, such as a concave shape that receives a wok or other cookware object with a correspondingly curved base. Such a non-planar shape may also be provided in the display and inductive coil, such as to provide a generally parallel alignment and consistent thicknesses of materials.

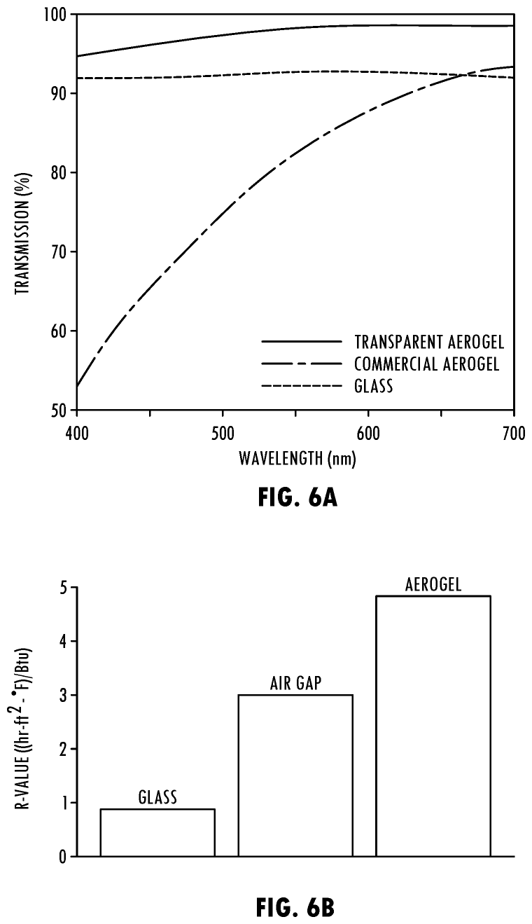

As shown in FIG. 2A, the transparent thermal insulator 24 is disposed between the top plate 12 and the display 22. In this example, the transparent thermal insulator 24 is a transparent aerogel, such as silica aerogel, that has a consistent thickness T of 5 mm to maintain the upper surface 22a of the display 22 below 40 degrees Celsius when the inductively heated cookware object is resting on the upper surface 18 of the top plate 12 and has a temperature of approximately 150 degrees Celsius. The thermal conductivity of an example of transparent aerogel having a thickness of 3 mm is 0.0126 W/m²K when measured on Netzsch 436 HFM. Also, the exemplary transparent aerogel has a vacuum R-value of 0.65 m²K/W when modeled at 10 kPa. When compared to air and glass, as shown in FIG. 6B, the exemplary transparent aerogel has an R-value of nearly 1.6 times that of air and nearly 5 times that of glass, where air has an R-value of approximately 3 (hr*ft2*F)/Btu), glass has an R-value of approximately 1 (hr*ft2*F)/Btu), and the transparent aerogel has an R-value of approximately 5 (hr*ft2*F)/Btu). It is contemplated that additional examples and implementations of different types of transparent aerogel may have different properties.

As shown in FIG. 3, the top plate 12 has an upper glass panel 26 that forms the upper surface 18 for supporting the cookware object 16. A lower glass panel 28 is provide over the upper surface of the display 22, such that the lower glass panel 28 may be an integral panel component of the display. The transparent thermal insulator 24 is sandwiched between the upper and lower glass panels 26, 28 in a layer with a generally uniform thickness, such as less than or equal to 5 mm or less than or equal to 7 mm. As shown in FIG. 3, the transparent thermal insulator 24 includes a homogenous panel of silica aerogel that is disposed in direct contact with the glass panels to provide an appearance of a single glass panel with a uniform thickness. Again, the term “glass” as used in describing the glass panels 26, 28 refers generally to its translucent and solid properties of the material, as the glass panels 26, 28 may include one or more of glass-ceramic, silica glass, porcelain, polymer thermoplastic, among other types of glass. For example, the upper glass panel 26 may include a glass-ceramic material and the lower glass panel 28 may include a silica glass or thermoplastic less thermal stability than the upper glass panel 26 due to its location below the transparent thermal insulator 24.

The transparent thermal insulator 24 has a thickness T and corresponding R-value between the upper surface 18 of the top plate 12 and the upper surface of the display 22 to prevent the cookware object 16 from heating the display 22 above a threshold temperature, such as a temperature that is capable of damaging or deteriorating the effectiveness of the display. However, to provide an efficient inductive coupling within the induction coil's operational threshold, the distance between the upper surface of the top plate 12 and induction coil 14 is preferably minimized. As shown in FIG. 4 for purposes of comparison, an air gap 25 is provide between upper and lower glass panels 26, 28 that has a substantially equivalent R-value to the thickness T of the transparent thermal insulator 24 shown in FIG. 3. In the arrangement shown in FIG. 4, the corresponding magnetic field that would need to be generated by the induction coil 14 is outside the safe operational threshold of the induction coil 14 for domestic appliances. Accordingly, the transparent thermal insulator 24 provides a greater insulating capacity than a static air gap 25, such the thickness of the transparent thermal insulator 24 is configured to create a distance between the induction coil 14 and the upper surface 18 of the top plate 12 that is less than the induction coil's operational threshold.

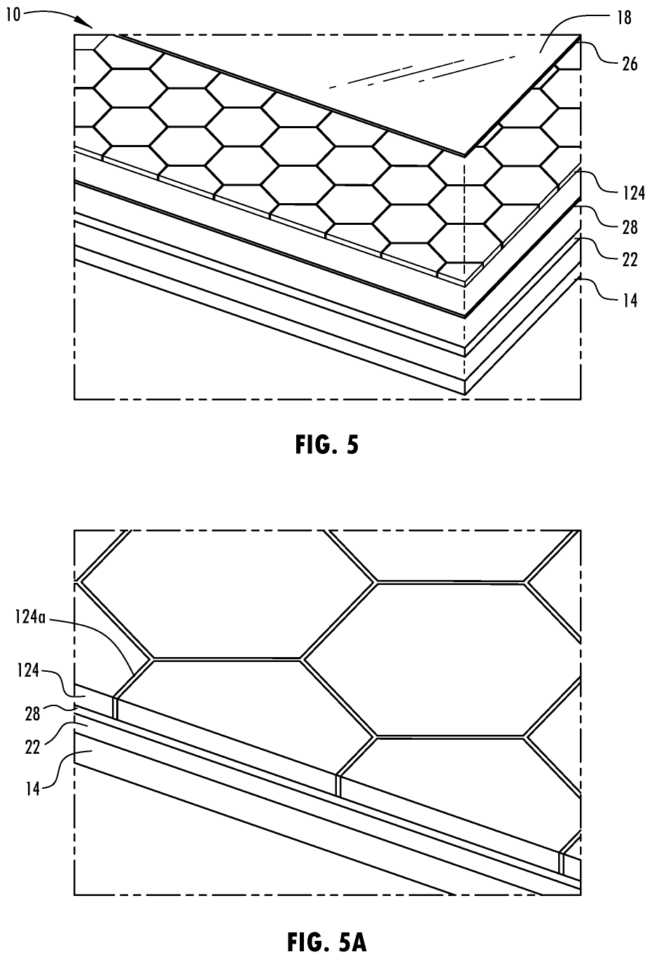

As shown in FIGS. 5 and 5A, an additional example of a transparent thermal insulator 124 is provided in a tiled arrangement. As such, the transparent thermal insulator 124 includes a number of individual tiles shaped to fit together in a planar arrangement or tessellation, such as the hexagonal shape shown in FIGS. 5 and 5A. The tiles are each formed with as a solid piece of silica aerogel, such as to have a planar lower surface that faces the display 22 and a planar upper surface that faces the upper surface 18 of the upper glass panel 26. When arranged together, the seams between the tiles, upper surfaces of the tiles, and/or lower surface of the tiles may be filled or flooded with a refractive index matching fluid 124a, as shown for example in FIG. 5A. The refractive index matching fluid 124a may include an adhesive to also improve structural stability of the assembled tile panel that forms the transparent thermal insulator 124. Also, it is contemplated that a bezel or frame may be provided around a perimeter of the transparent thermal insulator 124 to contain the refractive index matching fluid 124a and secure the panel.

The transparent thermal insulator 24, 124 has a visible transmittance generally greater than 70%, or in additional examples greater than 90% or greater than 94%. As such, the top plate 12 shown in FIG. 2 may have a corresponding visible transmittance between the upper surface 18 and the display 22 that is generally greater than 70%, or in additional implementations greater than 90% or greater than 94%. As shown in FIG. 6A, the visible transmittance of an example of transparent aerogel having a thickness of 3 mm is approximately 97%-98% when measured on Agilent Cary 5000 UV-Vis-NIR spectrophotometer. However, it is contemplated that additional examples and implementations of different types of transparent aerogel may have different optical properties.

The inductive cooktop 10 may include a controller, such as control system circuitry, that is coupled with and in communication with the induction coil 14 and the display 22 for the controller to control the display 22, such as to display information at the upper surface 18 of the top plate 12, including at an area or areas of the upper surface 18 that interface with a cookware object 16 that is inductively coupled with the induction coil 14. For example, as shown in FIG. 1A, the display 22 may display an image 32 that provide a warning indicator, shown as a red circle with the word “HOT” in the center area of the circle, at the area of the upper surface 18 of the top plate 12 that is still hot from the pan 16 that was previously inductively heated in the area, as shown in FIG. 1. The displayed red circle 32, thus, generally occupies the surface area on the upper surface 18 that was previously contacting the bottom surface of the pan 16 shown in FIG. 1. It is also contemplated that other information may be displayed at the display 22, including at the area of the display between the activated inductive coil and top plate before, during, or after operation of the induction coil inductively coupling with a cookware object. The displayed information may include operational information of the cooktop, outlines of cooking zones or control interfaces, control interfaces images, media widows or information, or branding or advertising windows or information and other conceivable images and graphics. For example, as shown in FIGS. 1-1B, the display displays a numerical timer 34 with a lead line 36 that connects the timer to the displayed circle 32 that corresponds to the cooking zone occupied by a cookware object or an area previously occupied by a hot cookware object. Another example shown in FIGS. 1 and 1A has the display displaying a visual timer 38 that is an arcuate peripheral line that surrounds a cooking zone, where the line radially diminishes along the circumference as the timer runs. Alternatively, it is contemplated that the peripheral line shown as a timer 38 in FIGS. 1 and 1A may function as a different type of indictor, such as a temperature for the cooking zone that it surrounds.

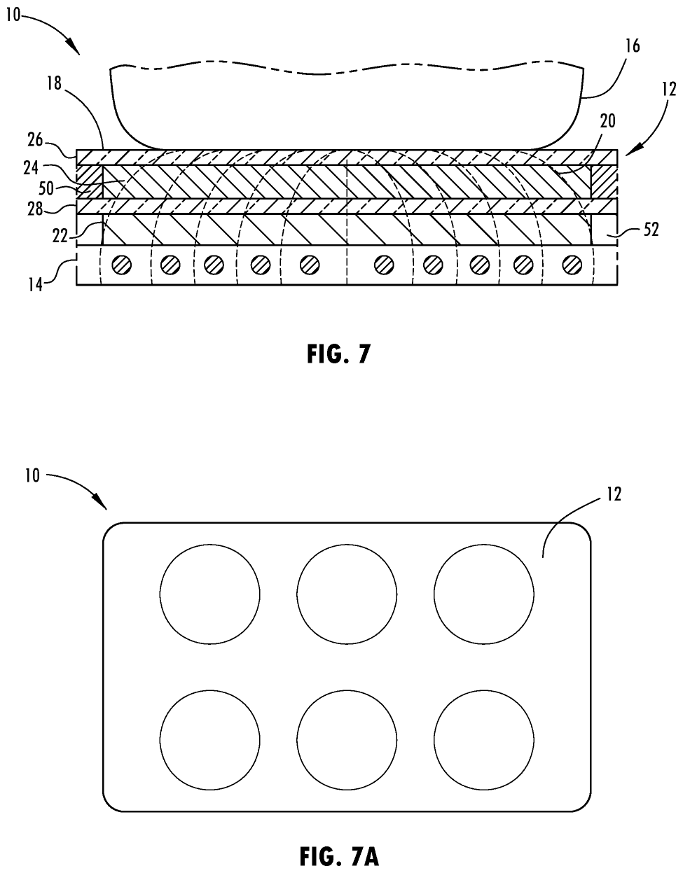

In some implementations, the upper surface 18 of the top plate 12 has a cooking area that is defined where the magnetic field generated by the induction coils generally overlaps with the upper surface of the top plate. Such a cooking area may be a zone formed or otherwise dedicated for a single cookware object. For example in a flexible cooktop 10 shown in FIGS. 1-1C, an array of induction coils are provided below the top plate, such that a grouping of coils may be activate to correspond with the desired cook area (e.g., to correspond with the location and size of a cookware object placed on the top plate). Alternatively, as shown for example in FIG. 7A, a static cooking area is identified, such as with screen printing, on the top plate, such that the induction coil or coils below the static cooking area generate the magnetic field for that specific static cooking area. In either case, the display 22 may be controlled to display information at the cooking area before, after, or during cooking with a cookware object placed on the cooking area and inductively coupled with the induction coil.

As further shown in FIGS. 7 and 7A, the static cooking area is provided with a dedicated display 22 and a dedicated transparent thermal insulator 24. As such, filler materials, such as lower cost and/or compression limiting materials, may be disposed adjacent to the dedicated display 22 and the dedicated transparent thermal insulator 24. As shown in FIG. 7, a standoff piece 50 is provided adjacent to the transparent thermal insulator 24 to act as a frame around the thermal insulator 24 and to prevent cookware objects 16 from exerting forces that would exceed a compression threshold of the silica aerogel, such as to prevent fail that would result from dropping a cookware object onto the upper surface 18. Similarly, a standoff piece 52 is provided adjacent to the display 22. The standoff pieces 50, 52 may include glass, plastic, or other suitable rigid materials.

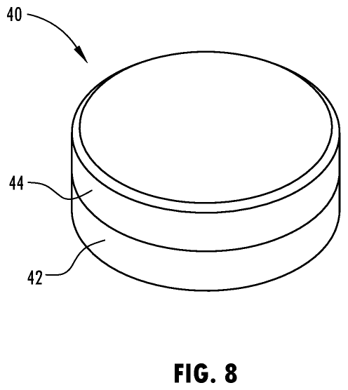

With reference to FIGS. 8-10, the inductive cooktop 10 may include a user interface device 40. As shown in FIG. 8, an implementation of the interface device 40 may have a base or lower portion 42 that is configured to magnetically attach at the upper surface 18 of the top plate 12 and a movable or upper portion 44 that is configured to receive user inputs for controlling at least one of the induction coil 14 and the display 22. The upper portion 44 of the interface device 40 may include a rotatable knob or dial that is rotatable relative to the lower portion 42 to provide user inputs that correspond with a radial position of the rotatable knob, such as to adjust temperature or cooking time or the like. The upper portion 44 may provide haptic feedback to the user, such as in response to rotation of the knob to a different setting or selection. It is also contemplated that the upper portion may be configured with additional or alternative input devices, such as button, capacity touch sensor, slider, switch, or the like to provide user inputs to the controller of the inductive cooktop. It is further contemplated that areas of the display (generally away from the cooking area) may have a touchscreen overlay to provide additional inputs to the inductive cooktop.

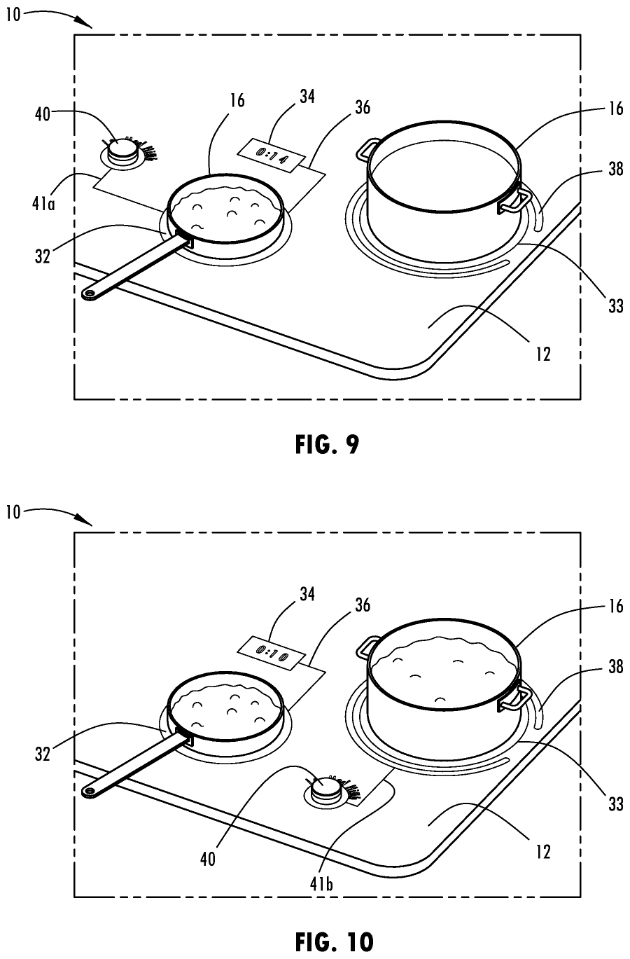

As shown in FIGS. 9 and 10, the user interface device 40 that may be removable and selectively attached to the upper surface 18 of the top plate 12 at a selected use location, such as adjacent to a portion or zone of the cooking area that interfaces with a cookware object 16. For example, the interface device 40 may be attached near one of the cookware objects 16 (FIG. 9), where a lead line 41a is displayed to connect the interface device 40 with the image 32 displayed beneath cookware object 16. As such, the inputs provided to the interface device 40 shown in FIG. 9 may be used to control the inductive coil or coils and the cooking settings in the zone occupied by the displaced image 32. The interface device 40 may also be attached near the other cookware object 16 (FIG. 10), where a lead line 41b is displayed to connect the interface device 40 with the image 33 displayed beneath cookware object 16. Similarly, the inputs provided to the interface device 40 shown in FIG. 10 may be used to control the inductive coil or coils and the cooking settings in the zone occupied by the displaced image 33. The display may also display information around the interface device 40, such as “Lo Med High” as shown in FIGS. 9 and 10, to correspond with the types of information that may be input.

Further, it is contemplated that the images displayed at the display may to correspond with a user profile, such as a preselected layout and contents of a control interface, such as in accordance with the accessible user settings. The display and corresponding inductive cooktop system may be connected or in communication with various systems and devices, such as wireless devices, databases, internet connectivity, accessory devices, appliances, thermostats, lighting, and security systems, among other conceivable systems and devices. Accordingly, the images displayed at the display may provide a control interface for operating or otherwise allowing the user to provide operational input to the connected systems and devices and allowing feedback from connected devices to be displayed. For example, icons may be displayed for various applications that provide corresponding control interfaces, such as for a recipes, oven control, dishwasher control, home security, weather, settings (for the display), video, among various other conceivable applications. By selecting a link, such as via pressing down on the upper portion of the rotatable knob or dial to actuate a button, the control interface may actuate the selected link, disappear, reposition, or minimize or various other conceivable user interface functionality. There are various conceivable arrangements, layouts, and settings of displayed content and user interface controls from that shown and described herein that may also be incorporated into other examples of the inductive cooktop. Also, the top plate 12 of the cooktop may function as a counter surface that is capable of easily being wiped clean of liquids, sauces, or other materials that may splash onto the upper surface from activities performed at the working surface of the countertop, cooktop, or sink or the like. Thus, the upper surface of the top plate may be capable of being easily sanitized, such as with UV light or a physical cleaning.

For purposes of this disclosure, the terms “upper,” “lower,” “right,” “left,” “rear,” “front,” “vertical,” “horizontal,” and derivatives thereof shall relate to the inductive cooktop as oriented in FIG. 1. However, it is to be understood that the inductive cooktop may assume various alternative orientations, except where expressly specified to the contrary. It is also to be understood that the specific devices and processes illustrated in the attached drawings and described in this specification are simply exemplary embodiments or implementations. Accordingly, the terminology that has been used is intended to be in the nature of words of description rather than of limitation. Hence, specific dimensions and other physical characteristics relating to the embodiments or implementations disclosed herein are not to be considered as limiting, unless the claims expressly state otherwise. Many modifications and variations of the embodiments and implementations are possible in light of the above teachings.

1. An inductive cooktop comprising:
a top plate having an upper surface configured to support a cookware object;
an induction coil disposed below the top plate and operable to generate an electromagnetic field that is configured to heat the cookware object;
a display disposed between the inductive coil and the top plate and operable to emit light through the top plate; and
wherein the top plate comprises a transparent thermal insulator that is configured to prevent the cookware object from heating the display above a threshold temperature.

2. The inductive cooktop of claim 1, wherein the display is configured to display information that is visible at the upper surface of top plate.

3. The inductive cooktop of claim 1, wherein the top plate comprises a visible transmittance between the upper surface and a lower surface of the top plate of greater than 70%.

4. The inductive cooktop of claim 1, wherein the top plate comprises an upper glass panel, a lower glass panel in planar parallel alignment with the upper glass panel, and the transparent thermal insulator disposed between the upper and lower glass panels.

5. The inductive cooktop of claim 1, wherein the transparent thermal insulator comprises a silica aerogel material having a thickness of less than 5 mm.

6. The inductive cooktop of claim 1, wherein the threshold temperature is 40 degrees Celsius.

7. The inductive cooktop of claim 1, wherein the display is generally void of ferrous metals.

8. The inductive cooktop of claim 1, wherein the display comprises an organic light emitting diode (OLED) display.

9. The inductive cooktop of claim 1, further comprising a controller coupled to the induction coil and the display, wherein the controller is configured to control the display to display a warning indicator at a portion of the upper surface of top plate that is hot.

10. The inductive cooktop of claim 1, wherein the upper surface of the top plate comprises a cooking area that is defined by an overlapping portion of the magnetic field at the upper surface, wherein, when a cookware object is placed on the cooking area and inductively coupled with the induction coil, the display is configured to display information at an interfacing portion of the cooking area that interfaces with the cookware object.

11. An inductive cooktop comprising:
a top plate having an upper surface configured to support a cookware object;
an induction coil disposed below the top plate and operable to generate an electromagnetic field at the upper surface of the top plate that defines a cooking area;
a display disposed between the inductive coil and the top plate and operable to display information through the top plate; and
a controller configured to control the display to display information at an interfacing portion of the cooking area of the upper surface that interfaces with a cookware object inductively coupled with the induction coil.

12. The inductive cooktop of claim 11, wherein the top plate comprises a transparent thermal insulator that is configured to prevent the cookware object from heating the display above a threshold temperature.

13. The inductive cooktop of claim 12, wherein the threshold temperature is 40 degrees Celsius.

14. The inductive cooktop of claim 12, wherein the top plate comprises an upper glass panel, a lower glass panel in planar parallel alignment with the upper glass panel, and the transparent thermal insulator disposed between the upper and lower glass panels.

15. The inductive cooktop of claim 12, wherein the transparent thermal insulator comprises a silica aerogel material having a thickness of less than 5 mm.

16. The inductive cooktop of claim 11, wherein the top plate comprises a visible transmittance between the upper surface and a lower surface of the top plate of greater than 70%.

17. The inductive cooktop of claim 11, wherein the display is void of ferrous metals.

18. The inductive cooktop of claim 11, wherein the controller is configured to control the display to display a warning indicator at a portion of the upper surface of top plate that is has a temperature above a threshold warning temperature.

19. The inductive cooktop of claim 18, wherein the controller is configured to determine a presence of the heated portion of the cooking area that has a cookware object inductively coupled with induction coil.

20. An inductive cooktop comprising:
a top plate having an upper surface configured to support a cookware object;
an induction coil disposed below the top plate and operable to generate an electromagnetic field at the upper surface of the top plate that defines a cooking area;
a display disposed below the top plate and operable to display information through the top plate; and
an interface device having a lower portion configured to magnetically attach at the upper surface of the top plate and an upper portion configured to receive user inputs for controlling at least one of the induction coil and the display.

21. The inductive cooktop of claim 20, wherein the upper portion of the interface device comprises a rotatable knob that is rotatable to provide user inputs that correspond with a radial position of the rotatable knob.

22. The inductive cooktop of claim 21, further comprising
a controller configured to control the display to display information at an interfacing portion of the cooking area of the upper surface that interfaces with a cookware object inductively coupled with the induction coil.

23. The inductive cooktop of claim 21, wherein the top plate comprises a transparent thermal insulator that is configured to prevent the cookware object from heating the display above a threshold temperature.

24. The inductive cooktop of claim 23, wherein the threshold temperature is 40 degrees Celsius.

25. The inductive cooktop of claim 23, wherein the top plate comprises an upper glass panel, a lower glass panel in planar parallel alignment with the upper glass panel, and the transparent thermal insulator disposed between the upper and lower glass panels.

26. The inductive cooktop of claim 23, wherein the transparent thermal insulator comprises a silica aerogel material having a thickness of less than 5 mm.

27. The inductive cooktop of claim 21, wherein the top plate comprises a visible transmittance between the upper surface and a lower surface of the top plate of greater than 70%.

28. The inductive cooktop of claim 21, wherein the display is void of ferrous metals.

29. The inductive cooktop of claim 21, wherein the controller is configured to control the display to display a warning indicator at a portion of the upper surface of top plate that is has a temperature above a threshold warning temperature.

30. The inductive cooktop of claim 29, wherein the controller is configured to determine a presence of the heated portion of the cooking area that has a cookware object inductively coupled with induction coil.
